(19) United States
(12) Patent Application Publication
(10) Pub. No.: US 2025/0061582 A1
(43) Pub. Date: Feb. 20, 2025

(54) Image Processing To Detect Edges, Walls, And Surfaces For A Virtual Painting Application

(71) Applicant: Behr Process LLC, Santa Ana, CA (US)

(72) Inventors: Douglas MILSOM, Tacoma, WA (US); Un Ho CHUNG, Santa Ana, CA (US); Kiki TAKAKURA-MERQUISE, San Mateo, CA (US); Lee SPRINGER, Castro Valley, CA (US)

(73) Assignee: Behr Process LLC, Santa Ana, CA (US)

(21) Appl. No.: 18/796,876

(22) Filed: Aug. 7, 2024

Related U.S. Application Data
(60) Provisional application No. 63/532,581, filed on Aug. 14, 2023.

(51) Int. Cl. G06T 7/12; G06T 7/136; G06T 11/00

(52) U.S. Cl. CPC G06T 7/12; G06T 7/136; G06T 11/001; G06T 2207/10024; G06T 2207/30168; G06T 2210/62

(57) ABSTRACT

A method includes uploading an image and a final edge map to a computing device, the image being a scene having at least one wall, at least one shadow, and at least one highlight, processing the image using a Segment-Anything model forming a processed image, performing wall segmentation on the processed image using the segment-anything model, performing segmentations of the processed image to generate a coarse wall mask, establishing a dynamic threshold of high confidence pixels to exclude small wall contours coordinates, performing a semi-random seed point generation, running the processed image through a second pass of the segment-anything model to remove additional segments below predetermined acceptable thresholds for noise before establishing a final predicted wall, generating the final predicted wall including a colorized image by applying color to the segmented wall to paint the at least one wall, and displaying the colorized image on a display.

### FIELD

The present disclosure relates to systems and methods of image processing to detect edges, walls, and surfaces within an uploaded image of a room and to virtually paint the room based on the detected edges, walls, and surfaces.

### BACKGROUND

This section provides background information related to the present disclosure which is not necessarily prior art.

Retail stores offering paint often have a plethora of sample cards positioned in a display to represent the number of paint colors available. However, selecting a paint color from the available paint colors can be a challenging task for a customer. For example, the customer may desire to match the paint color with furniture, flooring, window treatments, and/or decorations of an interior space.

More specifically, it is often difficult for a customer to visualize a wall of the interior space with a new paint color. In one approach, the customer may retrieve one or more sample cards from the retail store and tape the sample cards to the wall of the interior space. In another approach, the customer may purchase a small amount of paint in one or more colors and paint a portion of the wall of the interior space. However, these approaches are found to be time consuming, costly, and still leave the customer without a clear picture of what the interior space will look like with the new paint color.

Existing systems and methods for virtually painting an image of a room do not provide high-definition demarcation of the edges, walls, and surfaces within the image and are prone to have blurring at the edges and unpainted spaces between walls, corners, edges, etc.

### DRAWINGS

The drawings described herein are for illustrative purposes only of selected embodiments and not all possible implementations and are not intended to limit the scope of the present disclosure.

FIG. 1 is a schematic diagram of a system operating a plaint your place application in accordance with the present disclosure.

FIG. 2 is a flow chart of a method for executing the paint your place application.

FIG. 3 is another flow chart of the paint your place application in accordance with the present disclosure.

FIG. 4 is an example of coarse wall mask in accordance with the present disclosure.

FIG. 5 is an example of an image after application of a pixel threshold.

FIG. 6 is an example of an image after removing small wall contours.

FIG. 7 is another flow chart of the paint your place application in accordance with the present disclosure.

FIG. 8 is an example of a grayscale image of the image in accordance with the present disclosure.

FIG. 9 is an example of a re-gray image in accordance with the present disclosure.

FIG. 10 is another flow chart of the paint your place application in accordance with the present disclosure.

FIG. 11 illustrates an example of a source image and the resulting image mask after performing the processing of the present disclosure.

### SUMMARY

The present disclosure provides a method for enabling a user to paint an image uploaded to a device. Systems and methods of the present disclosure utilize machine-learning algorithms to improve the demarcation of walls and edges and the identification of segments within the image.

A method, in accordance with the present disclosure, includes uploading an image and a final edge map to a computing device, the image being a scene having at least one wall, at least one shadow, and at least one highlight, processing the image using a Segment-Anything model forming a processed image, performing wall segmentation on the processed image using the segment-anything model, performing segmentations of the processed image to generate a coarse wall mask, establishing a dynamic threshold of high confidence pixels to exclude small wall contours coordinates, performing a semi-random seed point generation along a horizontal axis of the processed image, running the processed image through a second pass of the segment-anything model to remove additional segments below predetermined acceptable thresholds for noise before establishing a final predicted wall, generating the final predicted wall including a colorized image by applying color to the segmented wall to paint the at least one wall, and displaying the colorized image on a display of the computing device.

In other features, the image is validated before performing the wall segmentation, where the validating includes determining whether the image meets a threshold for image quality.

In other features, a first value of a brightness and a second value of a contrast of the image are measured, a color of the image is balanced using the first and second values.

In other features, a grayscale function is performed on the image to generate a grayscale image.

In other features, a transparency function is performed on the image to generate an alpha gray image, where the alpha gray image represents the at least one shadow as an opaque region and represents the at least one highlight as a transparent region.

In other features, a normalization function is performed on the image to generate a re-gray image, where the normalization function includes measuring one or more values of at least one pixel of the image and normalizing the one or more values.

In other features, a colorized image is generated by applying a color to the final edge map and using the grayscale image, alpha gray image and re-gray image.

In other features, the colorized image is displayed on a display of the computing device.

In other features, performing the grayscale function includes gray scaling the image to generate a preliminary grayscale image and adjusting a value of at least one pixel of the preliminary grayscale image to generate the grayscale image.

In other features, performing the normalization function further includes determining a dominant color value of the image and the one or more values includes a color value, where normalizing the color values of the processed image uses the dominant color value.

In other features, performing the normalization function further includes detecting a contour in the processed image and the at least one pixel represents pixels of the contour.

In other features, the one or more values include a brightness value and a contrast value.

In other features, generating the colorized image includes applying a color on top of the alpha gray image.

In other features, generating the colorized image includes applying a color below the alpha gray image.

A system, in accordance with the present disclosure, includes a computing device having a processor and a memory, the computing device being configured to receive an image uploaded to the computing device, where the image is of a scene having at least one wall, processing the image using a Segment-Anything Model (SAM) to produce a set of initial Segment-Anything model results, perform a wall segmentation based on the set of initial SAM results, generate a final image mask, generate a colorized image by applying color to the final image mask to paint the at least one wall, and display the colorized image on a display of the computing device.

In other features, the computing device is further configured to validate the image before performing the wall segmentation on the set of initial SAM results, where the validating includes determining whether the image meets a threshold for image quality.

A system, in accordance with the present disclosure, includes a computing device having a processor and a memory, the computing device being configured to receive an image and a final edge map uploaded to the computing device, where the image is of a scene having at least one wall, processing the image using a Segment-Anything Model (SAM) to produce a set of initial Segment-Anything model results, perform a wall segmentation based on the set of initial SAM results, generate an image mask, generate a colorized image by applying color to the final edge map to paint the at least one wall, and display the colorized image on a display of the computing device.

In other features, the computing device is further configured to measure a first value of a brightness and a second value of a contrast of the image, and balance a color of the image using the first and second values.

A system, in accordance with a non-limiting example, includes a computing device having a processor and a memory, the computing device being configured to receive an image and a final edge map uploaded to the computing device, where the image is of a scene having at least one wall and the scene includes at least one shadow and at least one highlight, perform image segmentation, perform an image mask, where the image mask includes a segment wall coordinates of the wall, perform a grayscale function on the image to generate a grayscale image, perform a transparency function on the image to generate an alpha gray image, where the alpha gray image represents the at least one shadow as an opaque region and represents the at least one highlight as a transparent region, perform a normalization function on the image to generate a re-gray image, where the normalization function includes measuring one or more values of at least one pixel of the image and normalizing the one or more values, generate a colorized image by applying a color to the final edge map and using the grayscale image, alpha gray image and re-gray image, and display the colorized image on a display of the computing device.

In other features, the computing device is further configured to perform the grayscale function by gray scaling the image to generate a preliminary grayscale image, and adjust a value of at least one pixel of the preliminary grayscale image to generate the grayscale image.

In other features, the computing device is further configured to perform the normalization function by determining a dominant color value of the image and the one or more values includes a color value, wherein normalizing the color values of the image uses the dominant color value.

In other features, the computing device is further configured to perform the normalization function by detecting a contour in the image, wherein the at least one pixel represents pixels of the contour.

In other features, the one or more values include a brightness value and a contrast value.

In other features, the computing device is further configured to generate the colorized image by applying a color on top of the alpha gray image.

In other features, the computing device is further configured to generate the colorized image by applying a color below the alpha gray image.

Further areas of applicability will become apparent from the description provided herein. The description and specific examples in this summary are intended for purposes of illustration only and are not intended to limit the scope of the present disclosure.

Example embodiments will now be described more fully with reference to the accompanying drawings.

### DETAILED DESCRIPTION

The present disclosure provides a paint your place application that allows the customer to digitally visualize an interior space with a new paint color applied to one or more walls of the interior space. More specifically, the present disclosure provides an advanced recipe for the paint your place application that minimizes the number of inputs required by the customer for an efficient and reliable method for visualizing the interior space with the new paint color.

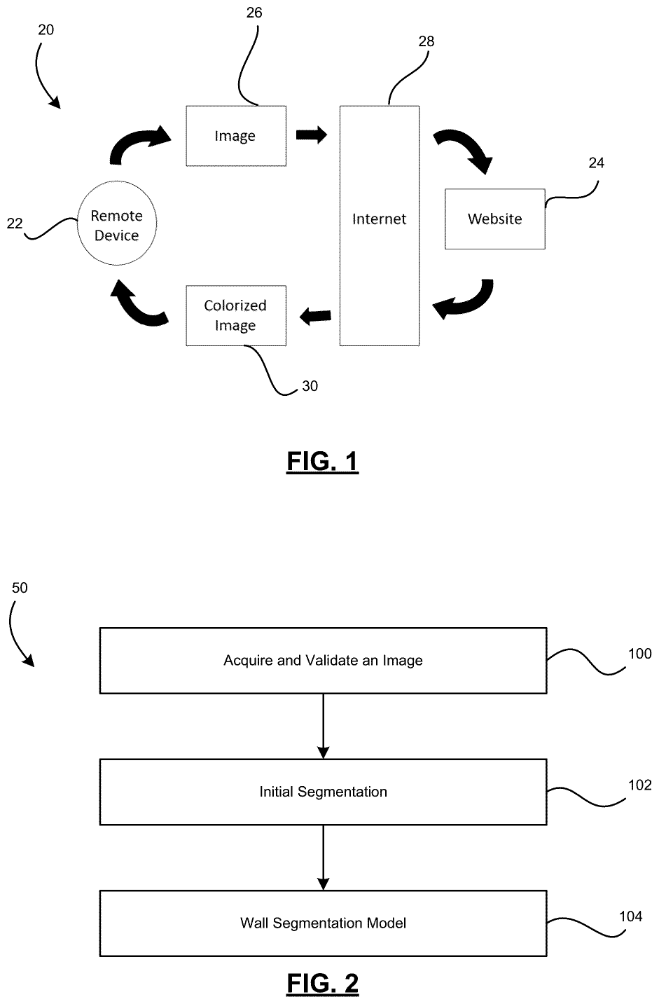

With reference to FIGS. 1-11, a paint your place application is provided that performs image processing to detect edges, walls, and surfaces within an uploaded image of a room and to virtually paint the room based on the detected edges, walls, and surfaces. The paint your place application enables a user to paint an image uploaded to a device. FIG. 1 illustrates a schematic diagram of a system in which a remote device 22 may access a website 24. In a non-limiting example, the remote device 22 may include a smart phone, a tablet, a kiosk inside a store, a computer, or other computing device having at least a memory and processor and that can access the website 24 over the internet 28. More specifically, a user may utilize a camera of the remote device 22 to capture an image 26, such as an image of a room that the user would like to paint. The image 26 may be transmitted to the website 24 through the internet 28. Additionally, or alternatively, the image may be transmitted via text message, such as through a multimedia messaging services (MMS), other messaging services, such as iMessage service, WhatsApp, etc., and/or via email. The user may interact with the website 24 over the Internet 28 via operations performed on the remote device 22. Such operations may be performed by, for example, a keyboard, a mouse, track ball, touch screen or other data entry means. In such a manner, various links presented on the remote device 22 may be selected by various point and click, point and touch, or other selection operations.

The website 24 may process the image 26 using image data, web pages, paint tools, and color databases to create a colorized image 30. The colorized image 30 may be transmitted from the website 24 to the remote device 22 using the Internet 28, and/or via MMS, other messaging services, etc., and/or email. In some embodiments, the website's 24 functionality may be implemented in software stored on a computer readable storage medium or media and executed by a suitable computing device. For example, the suitable device may be one or more digital processors or computers, which may comprise part of a web server or other suitable computing apparatus.

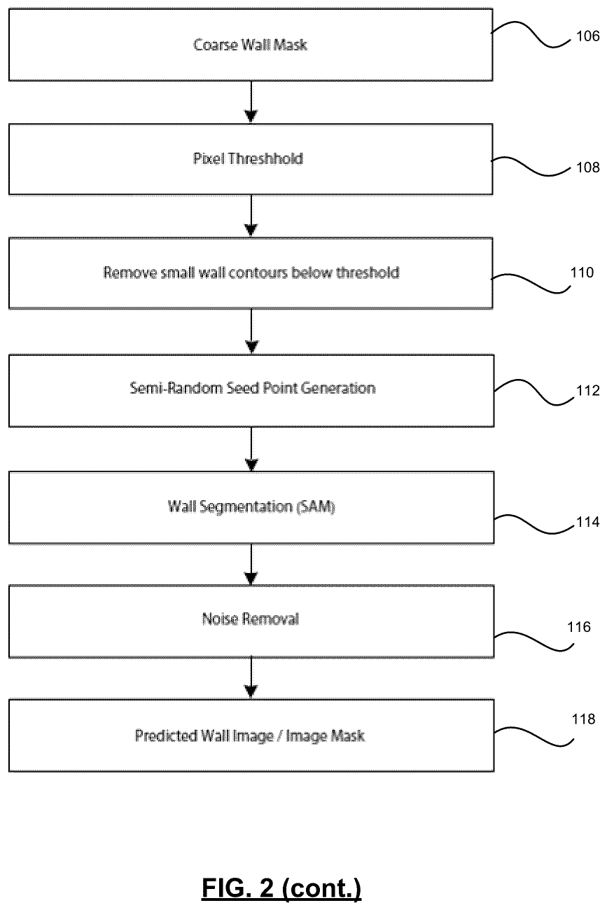

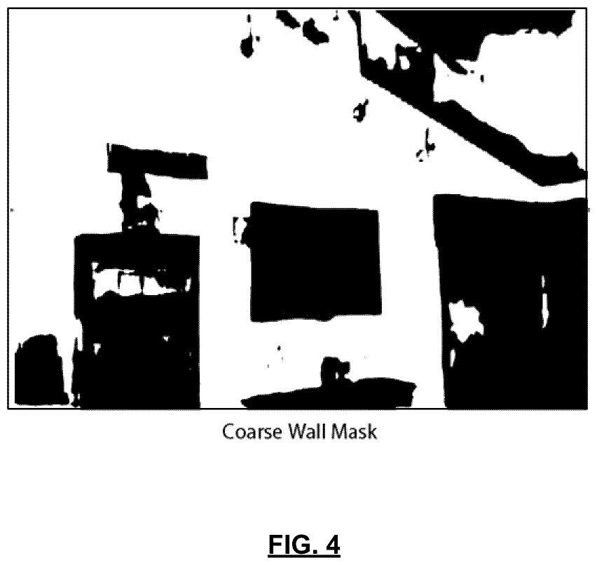

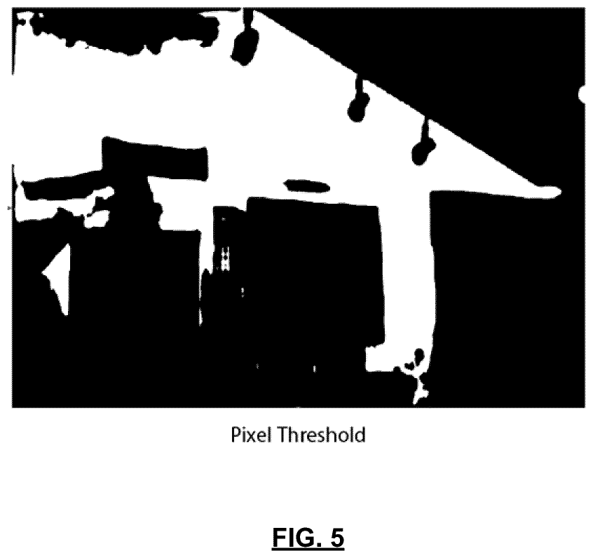

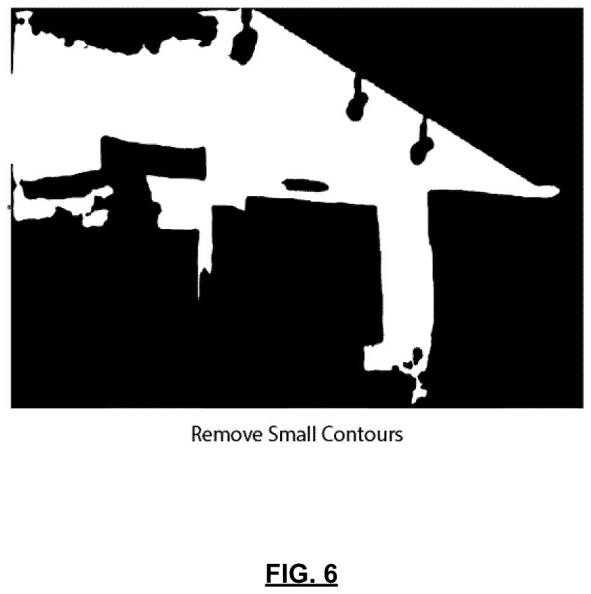

With reference to FIG. 2, a method 50 for executing the paint your place application of the present disclosure is provided. At 100, the method 50 includes acquiring and validating the image 26. For example, the scene may be an interior space of a building. The image 26 may be of a scene having at least one wall, such as a room within a house or other building that the user would like to paint. The interior space may include a living room having a wall, a ceiling, and a floor. In other examples, the scene may be of an exterior of a building. At step 102, the method 50 includes performing initial segmentation on the image 26 to get an initial wall mask of the image 26 to initially identify wall edges within the image. At step 104, the method 50 processing the image 26 through a wall segmentation model. For example, at step 104 the method 50 processes the image using a Segment Anything Model (SAM) available at https://arxiv.org/abs/2304.02643 and/or https://doi.org/10.48550/arXiv.2304.02643. Processing the image 26 through the wall segmentation model at step 104 results in a coarse wall mask at step 106. An example of a coarse wall mask of an image is illustrated, for example, in FIG. 4. At step 108, the method 50 applies a pixel threshold. An example of an image after application of a pixel threshold is illustrated, for example, in FIG. 5. The pixel threshold, for example, can be used to filter out noise and false edges/walls. For example, the lower portion of an image can show a floor of the room in the image and the pixel threshold can be used to exclude the floor from possible identification as a wall of the room in the image 26. At step 110, the method 50 removes small wall contours within the mask. An example of an image after removing small wall contours is illustrated, for example, in FIG. 6. At step 112, the method 50 performs a semi-random seed point generation. For example, the semi-random seed point generation may be performed along the horizontal axis of the image. At step 114, the method 50 processes the image 26 through the wall segmentation model a second time. Similar to step 104, at step 114 the method 50 processes the image using the Segment Anything Model (SAM) available at https://arxiv.org/abs/2304.02643 and/or https://doi.org/10.48550/arXiv.2304.02643. At step 116, the method 50 performs noise removal from the final mask image. At step 118, the method 50 generates a predicate wall image/image mask based on the final mask image after noise removal.

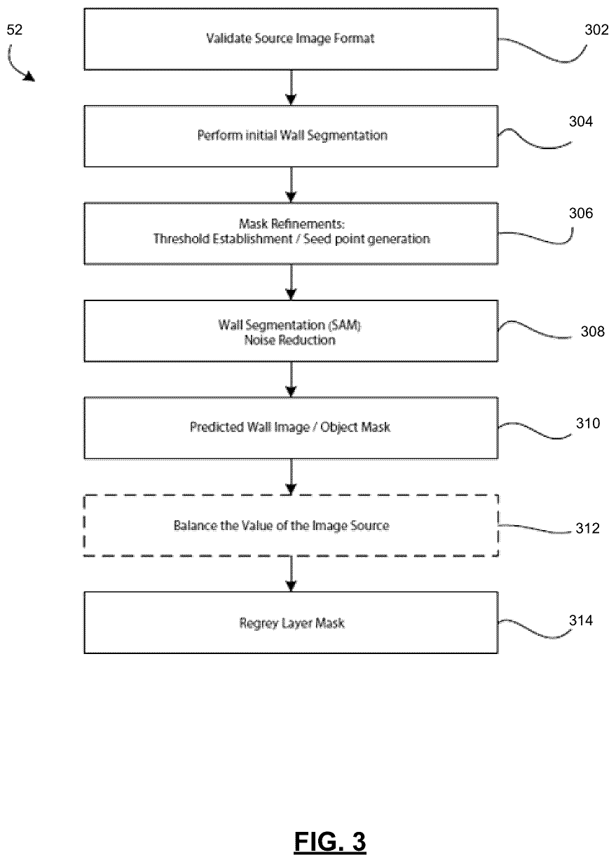

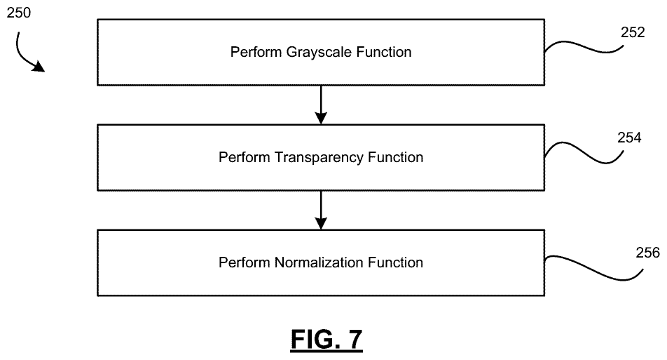

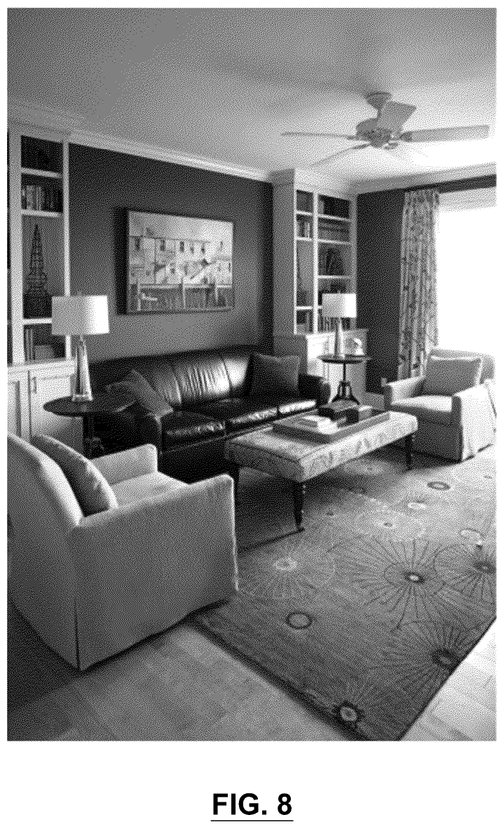

With reference to FIG. 3, another illustration of a method 20 for executing the paint your place application in accordance with the present disclosure is illustrated. At step 302, the method 52 validates the source image format. At step 304, the method 52 performs the initial wall segmentation. At step 306, the method 52 performs mask refinements, including threshold establishment and seed point generation. At step 308, the method 52 performs wall segmentation using the Segment Anything Model (SAM) and noise reduction are performed. At step 310, the method 52 generates a predicted wall image/object mask. At step 312, the method 52 optionally performs balancing a color of the image source using a previously measured value from the image source. Balancing the color of the image source is performed to improve the edge detection performance in subsequent steps. In one example, balancing the color of the image source may be performed if the image source is determined to be dark according to the brightness value. In another example, balancing the color of the image source may be performed to equalize a histogram of the image. In some embodiments, balancing the color is performed with “OpenCV.” At step 314, the method 52 performs re-greying of the layer mask, which is described in further detail with reference to FIGS. 7 and 8 below.

With reference to FIG. 7, a method 250 for developing a plurality of shade mattes is provided. At 252, the method 250 includes performing a grayscale function on the image source to generate a grayscale image. The grayscale function includes gray-scaling the image source to generate a preliminary grayscale image. More specifically, gray-scaling the image source is a conversion of an RBG pixel value to a single value ranging from 1 to 255, where the single value of 1 represents a black color and the single value of 255 represents a white color. Additionally, the grayscale function defines a maximum threshold value and a minimum threshold value. The grayscale function determines whether a value of the pixels in the preliminary grayscale image is greater than the maximum threshold value and whether the value of the pixels in the preliminary grayscale image is less than a minimum threshold value. If the value of a pixel in the preliminary grayscale image exceeds the minimum and maximum threshold values, the value of the pixel is adjusted to generate the grayscale image. In adjusting the value of the pixels that exceed the minimum and maximum threshold values, the grayscale function is removing contrast from the preliminary grayscale image. Removing contrast has the benefit of reducing a harshness of shadows for the grayscale image.

At 254, the method 250 includes performing a transparency function on the image source to generate an alpha gray image. The transparency function converts a value of the pixels of the image source such that a dark color is converted to value representing an opaque appearance and a light color is converted a value representing transparency. For example, a shadow in the image source may be converted to an opaque region and a highlight in the image source may be converted to a transparent region.

At 256, the method 250 includes performing a normalization function on the image source to generate a re-gray image. The normalization function includes measuring a color value of each pixel in the image source, determining a dominant color of the image source, and adjusting the color value of the pixels to return a smaller set of RGB colors. In some embodiments, a KMeans algorithm from Skimage is used for determining the dominant color of the image source. More specifically, the KMeans algorithm can be called, for example, as follows:

class sklearn.cluster.KMeans(n_clusters=8, *, init=‘k-
means++’, n_init=10, max_iter=300, tol=0.0001, verbose=0, random_state=
None, copy_x=True, algorithm=‘lloyd’)

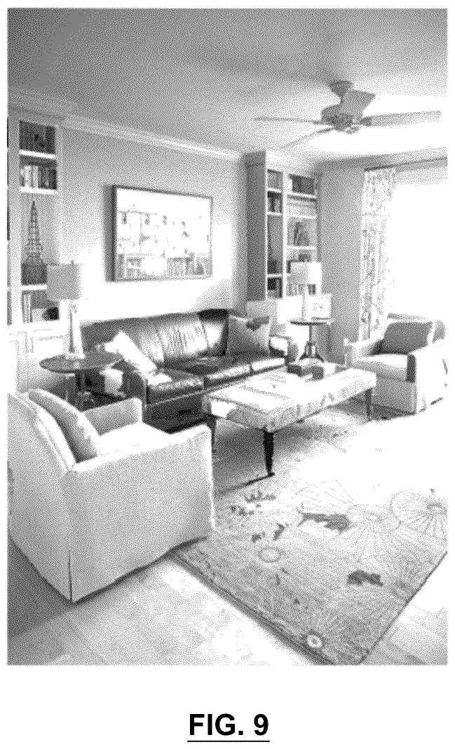

Additionally, the normalization function includes measuring a brightness value of each pixel in the image source and determining a mean brightness and measuring a contrast value of each pixel in the image source and determining a mean contrast. The normalization function is operable to detect contours within the image source and includes adjusting the brightness and contrast values of the pixels representing the contours using the mean brightness and mean contrast. FIG. 8 provides an example of a standard grayscale image and FIG. 9 provides an example of a re-gray image according to step 256 for the image. As shown, the re-gray image of FIG. 9 allows for a more favorable gray-scaled image to colorize in subsequent steps.

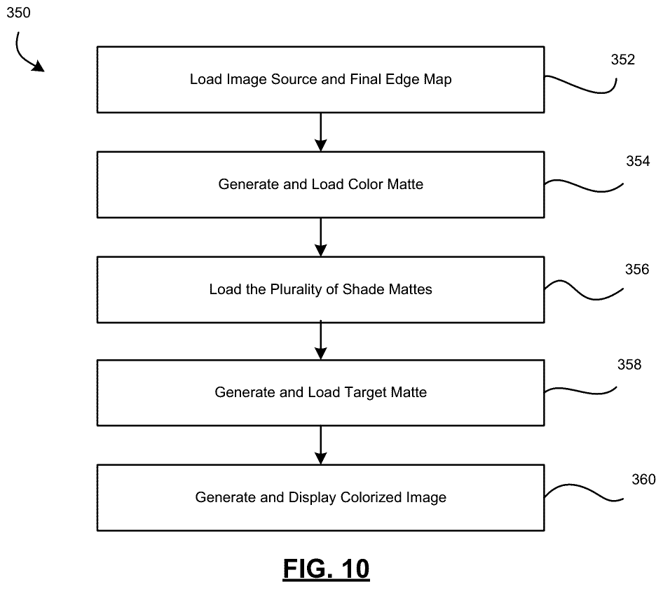

As shown in FIG. 10, a method 350 for processing the image is provided. At 352, the method 350 includes loading the image source and final edge map in HTML/Javascript. The final edge map may be a previously generated final edge map. In some embodiments, a final edge may be located off screen and a duplicate of the final edge map may be located on screen, such that the final edge map on screen is responsive to inputs from a user. Advantageously, the final edge map off screen can be utilized without losing fidelity and creating gaps in the edges due to loss of edge lines.

At 354, the method 350 includes generating and loading a plurality of color mattes in HTML/Javascript. The plurality of color mattes may include a color matte for each color available. The color mattes may be interchangeable such that one color can be replaced in all locations with a different color.

At 356, the method 350 includes loading the plurality of shade mattes in HTML/Javascript. The plurality of shade mattes may include a previously generated preliminary grayscale image, a previously generated grayscale image, a previously generated alpha gray image, and/or a previously generated re-gray image.

At 358, the method 350 includes generating and loading a target matte in HTML/Javascript. Generating the target matte may include combining the final edge map and the plurality of shade mattes such that shading is applied to the final edge map.

At 360, the method 350 includes generating and displaying a colorized image. More specifically, a user may interact with the remote device 22 to apply a color to a selected region of the target matte. The selected region may include a region outlined in the final edge map. In some examples, the user may apply a color to an interior wall of a building, such as a wall in a living room. In other examples, the user may apply a color to an exterior wall of a building. Generating the colorized image may include applying the color matte below or above the final edge map and below or above the plurality of shade mattes in order to provide a realistic appearance. Additionally, displaying the colorizing image may include displaying the colorized image on a display of the remote device 22.

Advantageously, the method 50 for the paint your place application allows the customer to digitally visualize a scene with a new paint color applied to one or more walls of the scene. Additionally, the method 50 minimizes the number of inputs required by the customer by automating the generation of edge maps and shade mattes for an efficient and reliable method that provides a high-resolution and high-definition demarcation of detected walls, edges, and surfaces within an uploaded image to produce a realistic visualization of the room that can be virtually pained with different paint colors selected by the user so that the user can visualize how the room will look once it is painted with the selected colors.

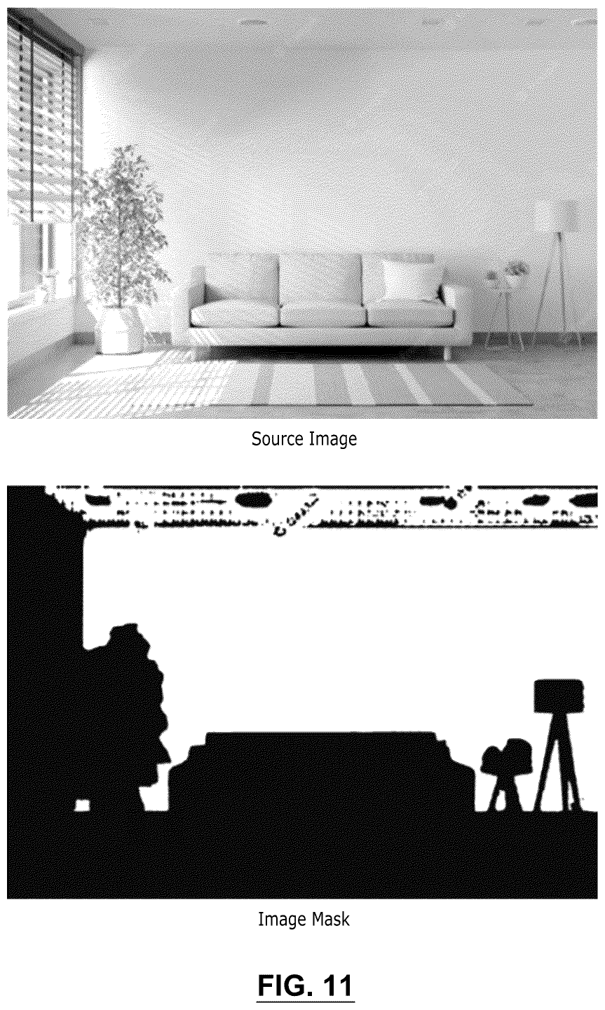

With reference to FIG. 11, an initial source image is shown along with the resulting image mask generated by the methods of the present disclosure, as described above.

The foregoing description of the embodiments has been provided for purposes of illustration and description and is not intended to be exhaustive or to limit the disclosure. Individual elements or features of a particular embodiment are generally not limited to that particular embodiment, but, where applicable, are interchangeable and can be used in another embodiment, even if not specifically shown or described. The various embodiments may also be varied in many ways. Such variations are not to be regarded as a departure from the disclosure, and all such modifications are intended to be included within the scope of the disclosure. Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Example embodiments are provided so that this disclosure will be thorough and will fully convey the scope to those who are skilled in the art. Specific details are set forth, including examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference and not to indicate a fixed order.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

We claim:

1. A method comprising:
uploading an image and a final edge map to a computing device, the image being a scene having at least one wall, at least one shadow, and at least one highlight;
processing the image using a Segment-Anything model forming a processed image;
performing wall segmentation on the processed image using the segment-anything model;
performing segmentations of the processed image to generate a coarse wall mask;
establishing a dynamic threshold of high confidence pixels to exclude small wall contours coordinates;
performing a semi-random seed point generation along a horizontal axis of the processed image;
running the processed image through a second pass of the segment-anything model to remove additional segments below predetermined acceptable thresholds for noise before establishing a final predicted wall;
generating the final predicted wall including a colorized image by applying color to the segmented wall to paint the at least one wall; and
displaying the colorized image on a display of the computing device.

2. The method of claim 1, further comprising validating the image before performing the wall segmentation, where the validating includes determining whether the image meets a threshold for image quality.

3. The method of claim 1, further comprising measuring a first value of a brightness and a second value of a contrast of the image, and balancing a color of the image using the first and second values.

4. The method of claim 1, further comprising performing a grayscale function on the image to generate a grayscale image.

5. The method of claim 1, further comprising performing a transparency function on the image to generate an alpha gray image, where the alpha gray image represents the at least one shadow as an opaque region and represents the at least one highlight as a transparent region.

6. The method of claim 1, further comprising performing a normalization function on the image to generate a re-gray image, where the normalization function includes measuring one or more values of at least one pixel of the image and normalizing the one or more values.

7. The method of claim 4, further comprising generating a colorized image by applying a color to the final edge map and using the grayscale image, alpha gray image and re-gray image.

8. The method of claim 7, further comprising displaying the colorized image on a display of the computing device.

9. The method of claim 4, wherein performing the grayscale function includes gray scaling the image to generate a preliminary grayscale image and adjusting a value of at least one pixel of the preliminary grayscale image to generate the grayscale image.

10. The method of claim 6, wherein performing the normalization function further includes determining a dominant color value of the image and the one or more values includes a color value, where normalizing the color values of the processed image uses the dominant color value.

11. The method of claim 10, wherein performing the normalization function further includes detecting a contour in the processed image and the at least one pixel represents pixels of the contour.

12. The method of claim 6, wherein, the one or more values include a brightness value and a contrast value.

13. The method of claim 7, wherein generating the colorized image includes applying a color on top of the alpha gray image.

14. The method of claim 7, wherein generating the colorized image includes applying a color below the alpha gray image.

15. A system comprising:
a computing device having a processor and a memory, the computing device being configured to:
receive an image uploaded to the computing device, where the image is of a scene having at least one wall;
processing the image using a Segment-Anything Model (SAM) to produce a set of initial Segment-Anything model results;
perform a wall segmentation based on the set of initial SAM results;
generate a final image mask, generate a colorized image by applying color to the final image mask to paint the at least one wall; and
display the colorized image on a display of the computing device.

16. The system according to claim 15, wherein the computing device is further configured to validate the image before performing the wall segmentation on the set of initial SAM results, where the validating includes determining whether the image meets a threshold for image quality.

17. A system comprising a computing device having a processor and a memory, the computing device being configured to:
receive an image and a final edge map uploaded to the computing device, where the image is of a scene having at least one wall;
processing the image using a Segment-Anything Model (SAM) to produce a set of initial Segment-Anything model results;
perform a wall segmentation based on the set of initial SAM results;
generate an image mask;
generate a colorized image by applying color to the final edge map to paint the at least one wall; and
display the colorized image on a display of the computing device.

18. The system according to claim 17, wherein the computing device is further configured to:
measure a first value of a brightness and a second value of a contrast of the image; and
balance a color of the image using the first and second values.

19. A system comprising a computing device having a processor and a memory, the computing device being configured to:
receive an image and a final edge map uploaded to the computing device, where the image is of a scene having at least one wall and the scene includes at least one shadow and at least one highlight;
perform image segmentation;
perform an image mask, where the image mask includes a segment wall coordinates of the wall;
perform a grayscale function on the image to generate a grayscale image;
perform a transparency function on the image to generate an alpha gray image, where the alpha gray image represents the at least one shadow as an opaque region and represents the at least one highlight as a transparent region;
perform a normalization function on the image to generate a re-gray image, where the normalization function includes measuring one or more values of at least one pixel of the image and normalizing the one or more values;
generate a colorized image by applying a color to the final edge map and using the grayscale image, alpha gray image and re-gray image; and
display the colorized image on a display of the computing device.

20. The system according to claim 19, wherein the computing device is further configured to:
perform the grayscale function by gray scaling the image to generate a preliminary grayscale image; and
adjust a value of at least one pixel of the preliminary grayscale image to generate the grayscale image.

21. The system according to claim 19, wherein the computing device is further configured to perform the normalization function by determining a dominant color value of the image and the one or more values includes a color value, wherein normalizing the color values of the image uses the dominant color value.

22. The system according to claim 21, wherein the computing device is further configured to perform the normalization function by detecting a contour in the image, wherein the at least one pixel represents pixels of the contour.

23. The system according to claim 19, wherein the one or more values include a brightness value and a contrast value.

24. The system according to claim 19, wherein the computing device is further configured to generate the colorized image by applying a color on top of the alpha gray image.

25. The system according to claim 19, wherein the computing device is further configured to generate the colorized image by applying a color below the alpha gray image.
